(19) United States
(12) Patent Application Publication
(10) Pub. No.: US 2017/0137625 A1
(43) Pub. Date: May 18, 2017

(54) ANTHRAQUINONE COMPOUND USED FOR COLOR FILTER OF LCD

(71) Applicant: Dow Global Technologies LLC, Midland, MI (US)

(72) Inventors: Yu Cai, Shanghai (CN); Hanfei Guo, Shanghai (CN); Guihong Liao, Shanghai (CN); Yang Li, Shanghai (CN); Chao He, Shanghai (CN); Hua Ren, Shanghai (CN)

(21) Appl. No.: 15/317,420

(22) PCT Filed: Jun. 17, 2014
(86) PCT No.: PCT/CN2014/080117

§ 371 Date: Dec. 9, 2016

(51) Int. Cl. C09B 1/32; G02F 1/1335; C09B 69/10; C09B 1/16; C08K 5/20

(52) U.S. Cl. CPC C09B 1/32; C09B 1/16; C08K 5/20; C09B 69/101; G02F 1/133514; G02F 2202/022

(57) ABSTRACT

An anthraquinone compound which is suitable for forming a color filter used for a liquid crystal display device, a composition containing a resin and the anthraquinone compound, an article having a polymer layer formed from the composition and a color filter formed from the composition are developed.

### FIELD OF THE INVENTION

The present invention relates to an anthraquinone compound which is suitable for forming a color filter used for a liquid crystal display device, a method for synthesis the anthraquinone compound, a composition containing a resin and the anthraquinone compound, an article having a polymer layer formed from the composition and a color filter formed from the composition.

### BACKGROUND OF THE INVENTION

Liquid crystal display (LCD) currently dominates the display market because of its excellent performance and small thickness. As a key component of LCD device, translucent color filters play the critical role of generating Red/Green/Blue lights by filtering white light from a back sheet. This capacity originates from the Red/Green/Blue colorants comprised in color filter units. Each colorant possesses a characteristic absorbance spectrum and will show one of the three primary colors when illuminated with white visible light-wavelength ranges from 380 nm to 780 nm. The controlled mixing of primary colors from each color filter unit produced by colorant will generate the final color of pixels. The efficiency of color filter directly impacts the LCD's performance.

Normally, the commercialized colorants used in a LCD color filter are pigments, because they have good stability against heat, light and chemicals. Unfortunately pigments must be ground into micro/nano particles before being added into a color resist to make a color filter due to their intrinsic insolubility property. When the color filter is illuminated, light scattering will take place on these particles with diameter of about 100 nm. As a result transmittance will be lowered, which means more light energy must be applied to provide enough brightness of the LCD.

In contrast to pigments, dyes are soluble in many materials which ensure that they can be dispersed at molecular level. If dyes are used in a color filter instead of pigments, light scattering will be significantly reduced. Thus it could be imagined that the dye based color filter will have higher transmittance and energy cost will thus be reduced greatly. However, dye's stability against light, heat and chemical resistance is generally inferior to pigments. As a result, at present, the commercialized LCD color filters contain pigments while a few LCD contain a hybrid (or combination) of pigment and dye.

Some anthraquinone dyes are used for color filters of a LCD. Some anthraquinone dye has been proposed for color filters, see e.g. CN102298263A, WO2006024617A, U.S. Pat. No. 6,713,641B, U.S. Pat. No. 3,918,976 and U.S. Pat. No. 6,593,483B, but those dyes generally have insufficient thermal stability or are insoluble in common organic solvent for a color filter.

Although the anthraquinone structure is stable, the low solubility of anthraquinone dyes in an organic solvent prevents the use of anthraquinone dyes for a color filter. Accordingly, an anthraquinone dye which is stable and satisfies the solubility in an organic solvent at the same time is still desired.

### SUMMARY OF THE INVENTION

Inventors of this invention have now found that new type of anthraquinone compound which is stable and has good solubility in an organic solvent.

Therefore, one aspect of the invention relates to an anthraquinone compound represented by the general formula (1)

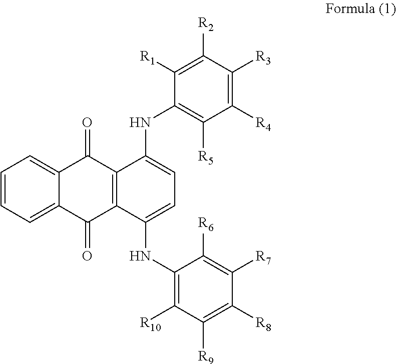

wherein R₁ to R₁₀ are independently selected from the group consisting of alkyl group having 1 to 20 carbon atoms, halogen atom, hydroxyl group, hydrogen atom, cyano group, sulfonyl group, sulfo group, aryl group, nitro group, alkoxyl group having 1 to 20 carbon atoms and -A-(N,N-diallylamide), wherein A is a linking group of hydrocarbon having 1 to 20 carbon atoms which can contain at least one heteroatom selected from oxygen atom and nitrogen atom, and at least one of R₁ to R₁₀ is -A-(N,N-diallylamide).

Another aspect of this invention relates to a method for synthesis the anthraquinone compound, the method comprises the step of reacting a diallyl amide compound selected from N,N-diallyl-2-chloroacetamide and N,N-diallyl-2-bromoacetamide with a compound represented by the following formula (9):

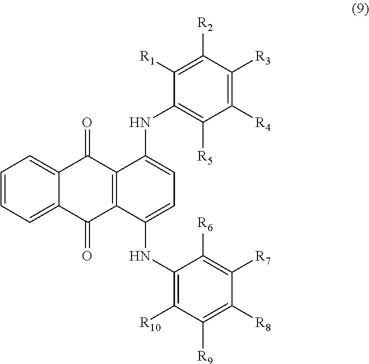

wherein R₁ to R₁₀ are selected from the group consisting of alkyl group having 1 to 20 carbon atoms, halogen atom, hydroxyl group, hydrogen atom, cyano group, sulfonyl group, sulfo group, aryl group, nitro group, alkoxyl group having 1 to 20 carbon atoms and hydroxyl group, at least one of R₁ to R₁₀ is hydroxyl group.

Further aspects of this invention relate to a composition comprising the anthraquinone compound and a resin or a reaction product of the anthraquinone compound with a resin; an article having a polymer layer formed from the composition and a color filter formed from the composition.

This group of anthraquinone compounds has high enough solubility for an organic solvent used for a LCD manufacturing process, so the anthraquinone compound of this invention is useful in a color filter used in a LCD. In addition, the allyl groups within the anthraquinone compounds can react with resin or other components in a color filter, so the color filter comprising the compound of this invention achieve higher thermal stability.

### DETAILED DESCRIPTION OF THE INVENTION

As used throughout this specification, the abbreviations given below have the following meanings, unless the context clearly indicates otherwise: g=gram; mg=milligram; mm=millimeter; min=minute(s); s=second(s); hr.=hour(s); rpm=revolution per minute; ° C.=degree Centigrade. Throughout this specification, “(meth)acrylic” is used to indicate that either “acrylic” or “methacrylic” functionality may be present. As used throughout this specification, the word ‘resin’ and ‘polymer’ is used interchangeably. The word ‘alkaline soluble resin’ and ‘binder’ is used interchangeably.

<Anthraquinone Compound>

The present invention provides an compound represented by the general formula (1).

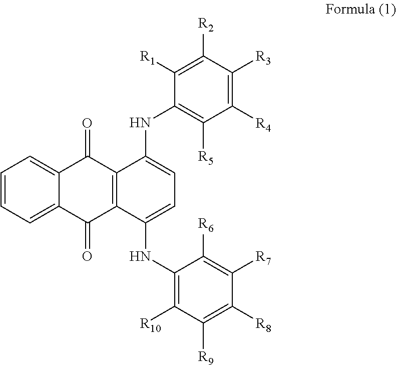

In the formula (1), R₁ to R₁₀ are selected from the group consisting of alkyl group having 1 to 20 carbon atoms, halogen atom, hydroxyl group, hydrogen atom, cyano group, sulfonyl group, sulfo group, aryl group, nitro group, alkoxyl group having 1 to 20 carbon atoms and -A-(N,N-diallylamide). A is a divalent linking group of hydrocarbon having 1 to 20 carbon atoms which can contain at least one heteroatom selected from oxygen atom and nitrogen atom. Hydrocarbon contains aromatic, alicyclic or aliphatic hydrocarbons or combination thereof. The hydrocarbon can contain at least one heteroatom selected from oxygen atom and nitrogen atom. At least one of R₁ to R₁₀ is -A-(N,N-diallylamide).

Preferably, R₁ to R₁₀ are selected from the group consisting of alkyl group, hydrogen atom and -A-(N,N-diallylamide).

The alkyl group has at least 1 carbon atom, and has less than 20 carbon atoms, preferably less than 4 carbon atoms. Examples of the alkyl group are; methyl, ethyl, propyl, butyl, hexyl, octyl, decyl, dodecyl, hexadecyl, octadecyl, isopropyl, sec-propyl, sec-butyl, tert-butyl, 2-ethylhexyl, cyclohexyl, 1-norbornyl and 1-adamantyl.

The alkoxyl group has at least 1 carbon atom, and has less than 20 carbon atoms, preferably less than 4 carbon atoms. Examples of the alkoxyl group are; methoxyl, ethoxyl, propoxyl, butoxyl, hexoxyl, octoxyl, sec-butoxyl and tert-butoxyl.

Preferred linking groups, A, are represented by the following formula (2) to (8).

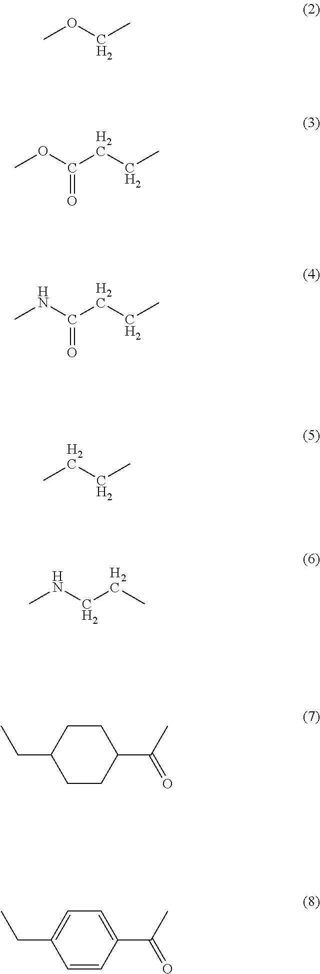

The compound of formula (2) is the most preferred.

Those compounds can be synthesized by introduction of at least one substituent which has diallylamide into at least one of aryl groups of diarylamine anthraquinone under the conditions (temperature, time, mol ratio or solvent) which are suitable for the synthesis. Examples of the methods for synthesis those anthraquinone compounds are disclosed below.

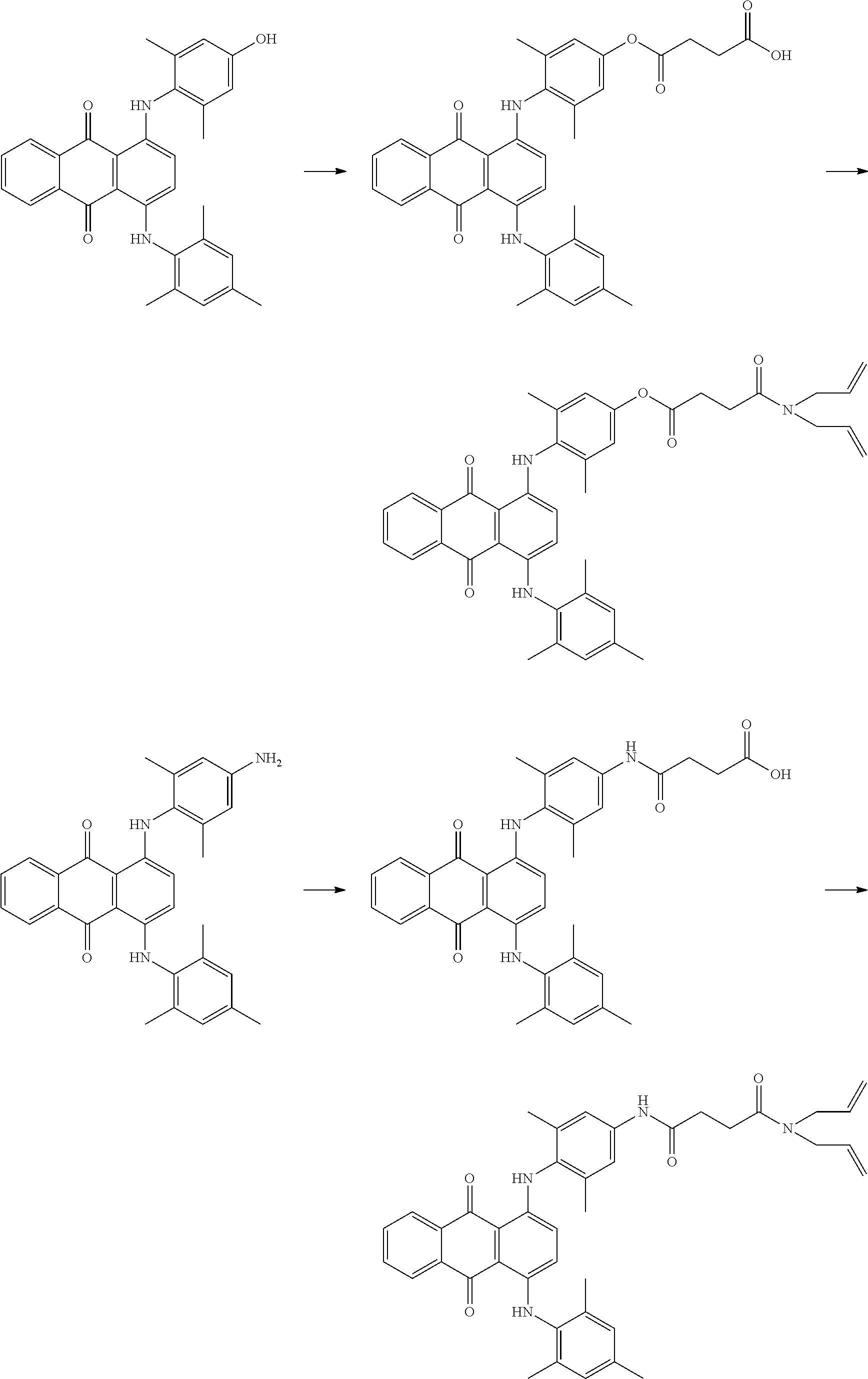 [SMILES: Cc1cc(C)c(Nc2ccc(Nc3c(C)cc(O)cc3C)c3c2C(=O)c2ccccc2C3=O)c(C)c1 ; Cc1cc(C)c(Nc2ccc(Nc3c(C)cc(OC(=O)CCC(=O)O)cc3C)c3c2C(=O)c2ccccc2C3=O)c(C)c1 ; C=CCN(CC=C)C(=O)CCC(=O)Oc1cc(C)c(Nc2ccc(Nc3c(C)cc(C)cc3C)c3c2C(=O)c2ccccc2C3=O)c(C)c1 ; Cc1cc(C)c(Nc2ccc(Nc3c(C)cc(N)cc3C)c3c2C(=O)c2ccccc2C3=O)c(C)c1 ; Cc1cc(C)c(Nc2ccc(Nc3c(C)cc(NC(=O)CCC(=O)O)cc3C)c3c2C(=O)c2ccccc2C3=O)c(C)c1 ; C=CCN(CC=C)C(=O)CCC(=O)Nc1cc(C)c(Nc2ccc(Nc3c(C)cc(C)cc3C)c3c2C(=O)c2ccccc2C3=O)c(C)c1]

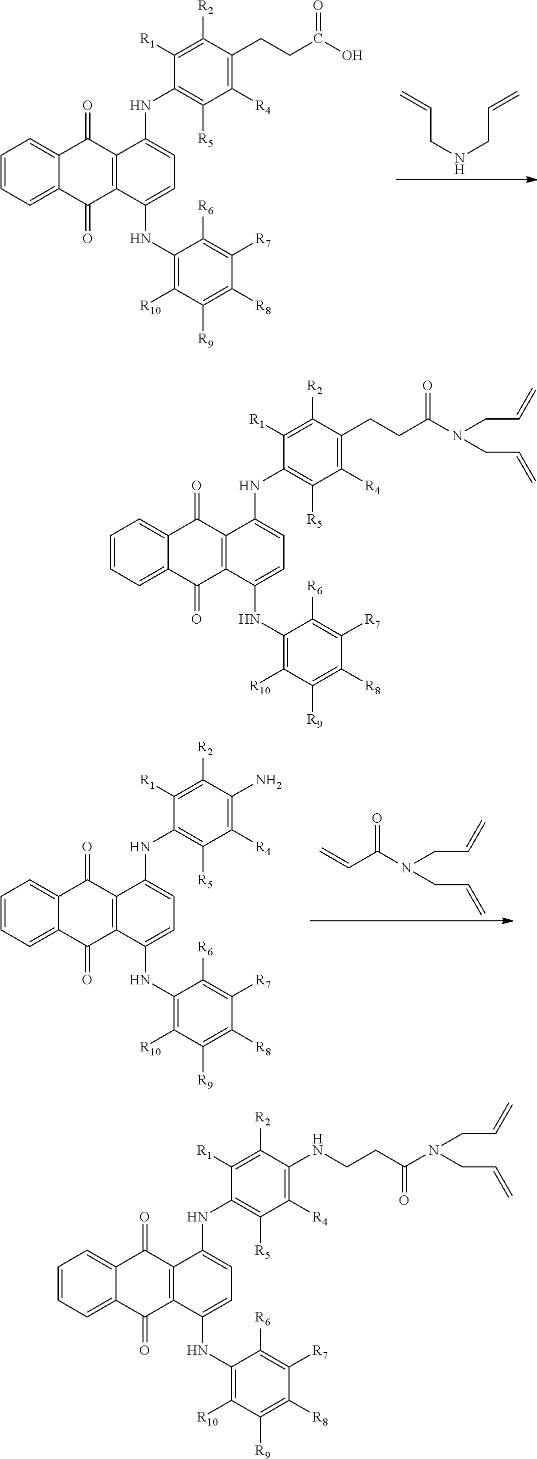

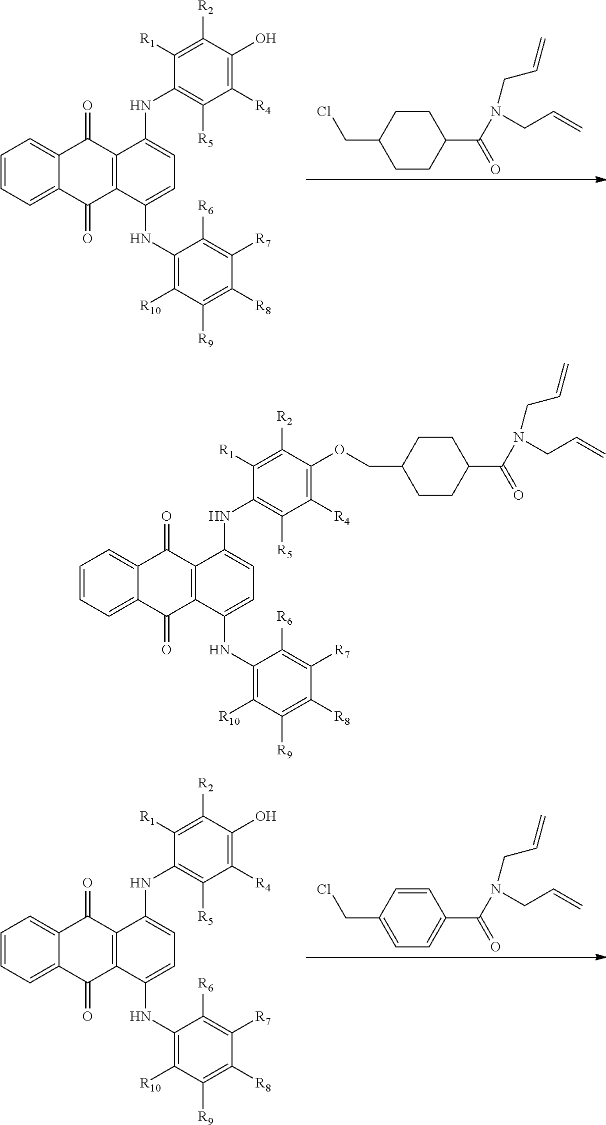

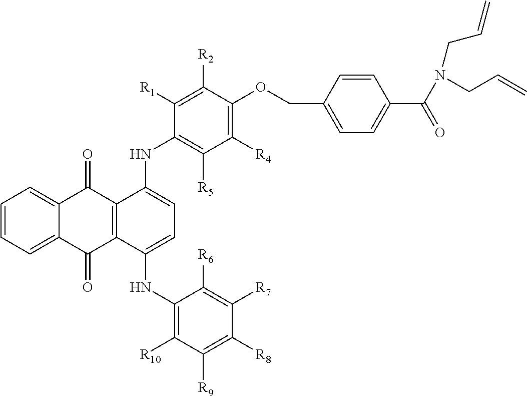

The anthraquinone compound of the present invention can be used as a mixture. For example, two or more of anthraquinone compounds which have different substituents as R₁ to R₁₀ of formula (1) compounds can be used as a mixture. A mixture of two or more of anthraquinone compounds can increase the solubility of the compounds in various organic solvents.

The anthraquinone compound of the formula (1) is useful in a color filter of a LCD since the anthraquinone compound of the invention has excellent thermal stability and high enough solubility for an organic solvent used in the manufacture of LCD such as propylene glycol monomethyl ether acetate (PEGMIA). The inventors of this invention expect that the diarylamine structure of the compounds will increase solubility of the compound.

Another aspect of the invention is a method for synthesis of the anthraquinone compound of which linking group disclosed as A is represented by the formula (2). The method comprises the reaction of a diallyl amide compound selected from N,N-diallyl-2-chloroacetamide and N,N-diallyl-2-bromoacetamide with a compound represented by the following formula (9).

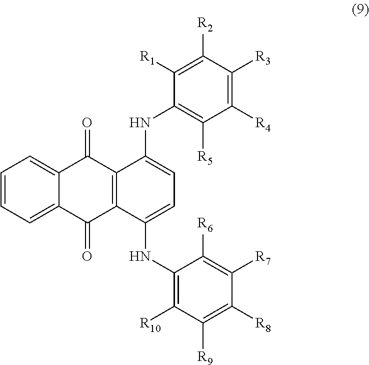

In the formula (9), R₁ to R₁₀ are selected from the group consisting of alkyl group having 1 to 20 carbon atoms, halogen atom, hydroxyl group, hydrogen atom, cyano group, sulfonyl group, sulfo group, aryl group, nitro group, alkoxyl group having 1 to 20 carbon atoms and hydroxyl group, at least one of R₁ to R₁₀ is hydroxyl group.

The compound represented by the formula (9) can be synthesized by the following two steps. The first step is a reaction of a mixture of 2,3-dihydro-9,10-dihydroxy-1,4-anthraquinone (lecoquinzarin) and 1,4-dihydroxyanthraquinone (quinzarin) with a hydroxylaniline or derivatives thereof under the presence of at least one catalyst. Examples of the catalyst include boric acid and tryalkyl borate. An example of the reaction is disclosed below:

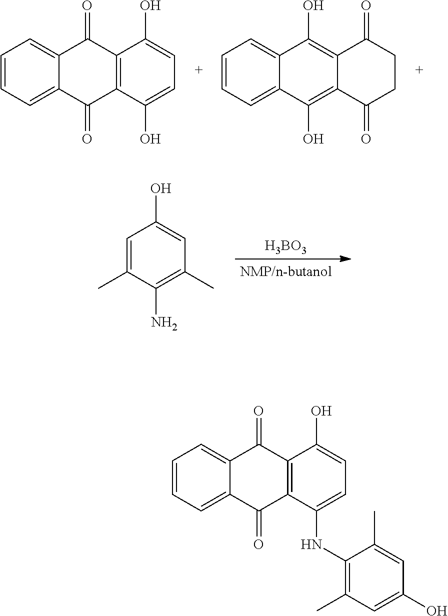

The second step is a reaction of the reaction compound of the first step with an aniline or derivatives thereof under the presence of at least one catalyst. The catalyst of the reaction is preferably boric acid. In addition, zinc powder and acid are used to help the reaction. Examples of the acid include propionic acid, pivalic acid, trifluoroacetic acid, 2,2-dimethylbutyric acid and mixtures thereof. An example of the second step is disclosed below:

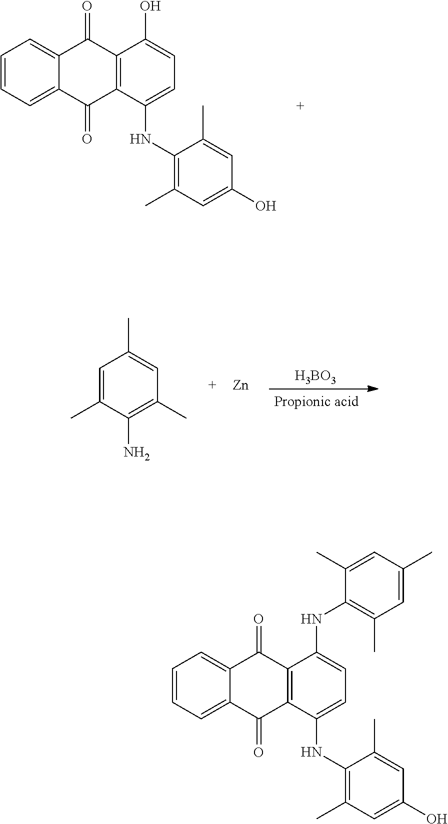

N,N-diallyl-2-chloroacetamide is commercially available and can be used as it is.

The reaction of the compound designated by the formula (9) and the diallyl amide compound selected from N,N-diallyl-2-chloroacetamide and N,N-diallyl-2-bromoacetamide is conducted in the presence of a base adjuvant. Examples of the base include sodium hydroxide, potassium hydroxide, sodium carbonate, potassium carbonate, cesium carbonate.

At least one phase transfer catalyst optionally can be used in the reaction. Phase transfer catalyst used here is a catalyst that helps solubilize ionic compounds into organic solutions. Examples of phase transfer catalyst include tetrabutylammonium bromide, tetraethylammonium bromide and cetyltrimethylammonium bromide.

Solvent used in the reaction can be selected from any known solvents. Examples of the solvent include tetrahydrofuran(THF), dioxane, N,N-dimethylformamide(DMF), acetonitrile and N-methyl-2-pyrrolidone. The temperature and time of the reaction are vary depending on the kind of solvent or other conditions, but it is from 50 to 200° C. for 3 to 36 hours.

The mole ratio of the compound designated by the formula (9)/the diallylamide compound selected from N,N-diallyl-2-chloroacetamide and N,N-diallyl-2-bromoacetamide is preferably 1/1 or less, more preferably 2/3 or less.

<Composition>

The composition of the present invention comprises at least one compound as recited in formula (1) and a resin. The resin is preferably alkaline soluble resin. The compounds represented by formula (1) can react with a resin, because the anthraquinone compound has allyl groups within the molecule. Therefore, in such cases the composition of the present invention comprises a reaction product of the compounds represented by formula (1) with a resin. The composition preferably additionally comprises a cross-linker (cross-linking agent), a solvent and a radiation-sensitive compound such as a photo initiator. The composition can form a film useful for a color filter.

The content of the compound as recited in formula (1) in the composition of the present invention varies depending on each molar absorption coefficient and required spectral characteristics, film thickness, or the like, but it is preferably at least 1 wt %, more preferably at least 2 wt %, the most preferably at least 5 wt % based on the total solid contents of the composition. The preferable content is less than 55 wt %, more preferably less than 45 wt %, most preferably less than 35 wt % based on the total solid contents of the composition.

The composition of the present invention can comprise other coloring materials in addition to the compound as recited in formula (1). Normally the use of additional coloring material is determined from the required spectral characteristics of a material to be formed from the composition.

The alkaline soluble resin is also known as ‘binder’ in this technical art. Preferably, the alkaline soluble resin is dissolved in an organic solvent. The alkaline soluble resin can be developed with an alkaline solution such as tetramethyl ammonium hydroxide aqueous solution (TMAH) after forming a film.

The alkaline soluble resin (binder) is normally a linear organic polymer. The binder optionally has a crosslinkable group within the polymer structure. When the composition of the present invention is used as a negative type photosensitive composition, such crosslinkable group can react and form crosslink by exposure or heating so that the binder becomes a polymer which is insoluble in alkaline.

Many kinds of binder are known in this art. Examples of such binder are; (meth)acrylic resin, acrylamide resin, styrenic resin, polyepoxyde, polysiloxane resin, phenolic resin, novolak resin, and co-polymer or mixture of those resins. In this application, (meth)acrylic resin (polymer) includes copolymer of (meth)acrylic acid or ester thereof and one or more of other polymerizable monomers. For example, acrylic resin can be polymerized from acrylic acid and/or acrylic ester and any other polymerizable monomers such as styrene, substituted styrene, maleic acid or glycidyl (meth)acrylate.

The binder preferably has at least 1,000 of weight-average molecular weight (Mw), more preferably at least 2,000 of Mw measured by a GPC method using polystyrene as a standard. At the same time, the binder preferably has less than 200,000 of Mw, more preferably less than 100,000 of Mw measured by the same method described above.

The amount of the binder used in the composition of the present invention is preferably at least 10 wt %, more preferably at least 20 wt % based on the total solid contents of the composition. At the same time, the preferable amount of the binder is less than 80 wt %, more preferably less than 50 wt %, the most preferably less than 30 wt % based on the total solid contents of the composition.

The composition of this invention optionally further comprises a cross-linking agent to obtain a further hardened material. It is also known as a radical-polymerizable monomer. When the composition of this invention is used as a negative type photosensitive composition, such cross-linking agent can form a crosslink by exposure or heating and contribute to get a further hardened material. Well known cross-linking agent can be used for the composition of this invention. Examples of cross-linking agents are epoxy resin, dipentaerythritolhexaacrylate (DPHA) and substituted nitrogen containing compound such as melamine, urea, guanamine or glycol uril.

The composition of this invention optionally further comprises a solvent. The solvent to be used for the composition is not limited, but preferably selected from the solubility of components of the composition such as alkaline soluble resin or anthraquinone compound. Examples of the preferable solvent include esters such as ethyl acetate, n-butyl acetate, amyl formate, butyl propionate or 3-ethoxypropionate, ethers such as diethylene glycol dimethyl ether, ethylene glycol monomethyl ether or propylene glycol ethyl ether acetate and ketones such as methylethylketone, cyclohexanone or 2-heptanone.

When the composition of this invention is a negative type radiation-sensitive composition, the composition preferably comprises a photo initiator. Photo initiator also called as photopolymerization initiator and including radical initiator, cationic initiator and anionic initiator. Examples of a photo initiator include; oxime esther type initiator, sulfonium salts initiator, iodide salts initiator and sulfonate initiator.

The composition of this invention can comprise other radiation-sensitive compound such as a radiation sensitive resin or a photo acid generator.

<Polymer Layer>

The composition of the present invention described above can form a polymer layer on an article. The polymer layer also described as ‘polymer film’ in the specification. The polymer layer formed from the composition has excellent thermal stability. Without wishing to be bound to the theory, the inventors of this invention expect that the anthraquinone compounds represented by formula (1) can react with polymerizable compounds in the composition during those are heated, because the anthraquinone compound has allyl groups within the molecule. Those reactions will improve thermal stability of the anthraquinone compounds of formula (1) due to their increased molecular weight. Examples of those polymerizable compounds include a resin, a cross-linking agent and the anthraquinone compound itself (self polymerization).

The content of the compound as recited in formula (1) in the polymer layer is depend on the required color of the film, and it is basically the same as the content of the compound as recited in formula (1) in the composition. The polymer layer also comprises an alkaline soluble resin which is disclosed above.

The polymer layer optionally comprises a photo initiator, a photo acid generator, a radiation sensitive resin and a crosslink agent disclosed above.

The method of forming the polymer layer on an article comprises the steps of; mixing the compound as recited in formula (1) with an alkaline soluble resin and solvent, coating the mixture on an article which supports a layer and heating the article to form a polymer layer (film). Optionally, the method comprises one or more of steps of exposing a layer (film) or curing a layer to form crosslinked stable layer.

The alkaline soluble resin and the solvent used to the method for forming the polymer layer are same as the one disclosed above.

Examples of an article which supports a layer (film) are glass, metal, silicon substrate and metal oxide coated material.

Any coating method can be used for the coating step, such as rotation coating, cast coating or roll coating.

The thickness of the layer (film) varies depending on the required properties of the film. The thickness of the layer is 0.1 to 5 micron, preferably 0.5 to 3 micron.

The layer (film) has high transmittance and thermal stability from the properties of the anthraquinone compound of this invention. The anthraquinone compound can be dissolved in an organic solvent, and has high thermal stability. Therefore the compound does not prevent the transmittance of a film and does not decrease the thermal stability of the film. Such property is important for a color filter of LCD. Therefore, the layer (film) of the present invention is useful as a color filter of LCD.

<Color Filter>

The color filer of this invention is formed from the composition comprising at least one compound as recited in formula (1) and a resin. The layer (film) disclosed above can be used for the color filter. Normally, a color filter has multiple units which made from colored films comprising Red/Green/Blue colorants.

The content of the compound as recited in formula (1) in a colored film for a color filter is basically the same as the content in the film disclosed above.

A film used for a color filter can be formed by the following steps; coating a solution comprising the compound as recited in formula (1), binder, a photo initiator and solvent to form a radiation sensitive composition layer on a material, exposing the layer through a patterned mask, and developing the layer with an alkaline solution. Moreover, a curing step of further heating and/or exposing the layer after developing step may be conducted as needed.

Since a color filter comprises three colored films which comprise R/G/B colorant, the steps of forming each colored film are repeated, then a color filter having such three colored films are obtained.

### EXAMPLES

### Inventive Example 1

An anthraquinone dye (Dye 1) disclosed below was used in Inventive Example 1.

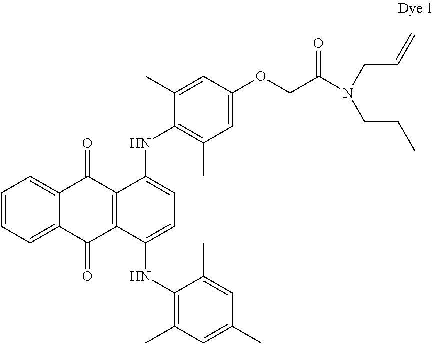 [SMILES: C=CCN(CCC)C(=O)COc1cc(C)c(Nc2ccc(Nc3c(C)cc(C)cc3C)c3c2C(=O)c2ccccc2C3=O)c(C)c1]

Synthesis of Dye 1

a. Synthesis of 1-hydroxy-4-(2′,6′-dimethyl-4′-hydroxyanilino)anthraquinone

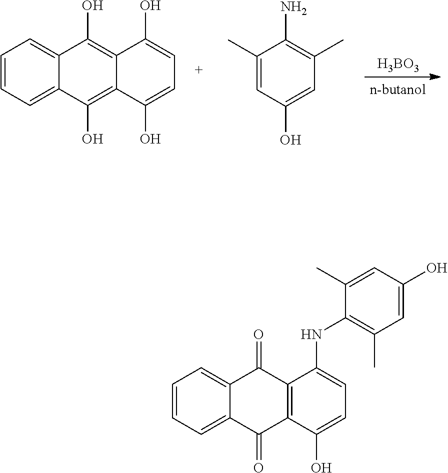

A mixture of 2.4 g (9.91 mmol) of 1,4,9.10-tetrahydroxylanthracene, 1.36 g (1 equiv.) of 2,6-dimethyl-4-hydroxylaniline, 1.0 g (16.2 mmol) of boric acid and 12 mL of n-butanol was refluxed at normal pressure for 25 hours in an oil bath at 115° C. under N₂. The reaction mixture was cooled to room temperature and 1 mL of 6N HCl solution was added while stirring. The mixture was crystallized in ice-bath and filtered. The crude solid product was washed with water and dried under dynamic vacuum. Finally 712 mg of the pure product was obtained by column chromatography on silica using methylene chloride as eluent. Yield: 20%. ¹H NMR (CDCl₃, ppm): 13.65 (s, 1H), 11.15 (s, 1H), 8.33 (m, 2H), 7.74 (m, 2H), 7.05 (d, 1H), 6.67 (d, 1H), 6.59 (s, 2H), 4.79 (br, 1H), 2.07 (s, 6H)

b. Synthesis of 1-((4-hydroxy-2,6-dimethylphenyl)amino)-4-(mesitylamino)-anthraquinone

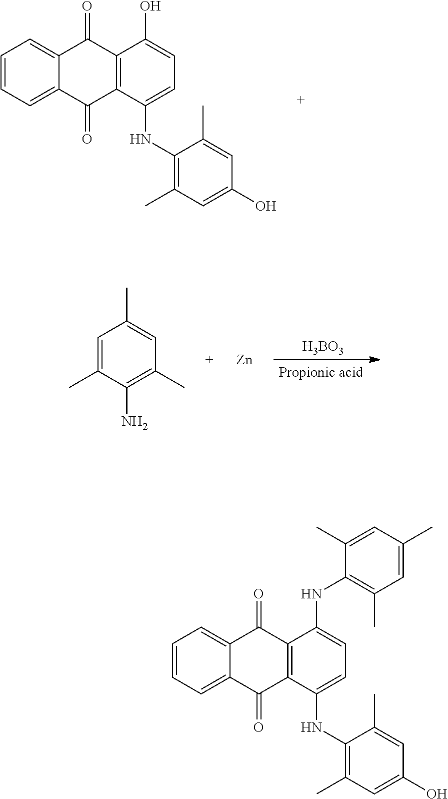

A mixture of 1.00 g (2.8 mmol) of 1-hydroxy-4-(2′,6′-dimethyl-4′-hydroxyanilino)anthraquinone, 3.76 g (27.8 mmol) of trimethylaniline, 0.20 g (3.2 mmol) of boric acid, 0.20 g (3.1 mmol) of zinc dust, 2.0 g propionic acid was heated at 160° C. for 6 hours in an oil bath under N₂. The reaction mixture was poured into 100 mL of crushed ice containing 10 mL of concentrated hydrochloric acid. The residue remaining in the reaction flask was transferred to the ice-acid mixture using 8 mL of propionic acid. The stirred mixture was heated to 55° C. and filtered to give the mixed product. Then the crude product was washed with 5% hydrochloric acid, and water. After dried, the final product was purified by silica gel column using methylene chloride as eluent. 796 mg of the unsymmetrically substituted 1,4-diarylamino-anthraquinone derivative was obtained with the yield of 60%. ¹H NMR (CDCl₃, ppm): 11.74 (s, 1H), 11.60 (s, 1H), 8.35 (m, 2H), 7.69 (m, 2H), 6.86 (s, 2H), 6.54 (s, 2H), 6.50 (s, 2H), 5.22 (s, 1H), 2.22 (s, 3H), 2.07 (s, 6H), 2.02 (s, 6H). ESI-MS (m/z, Ion, Formula): 477, (M+H)⁺, C31H29N2O3, (theoretical mass 476)

c. Synthesis of N,N-diallyl-acetamide modified anthraquinone (Dye 1)

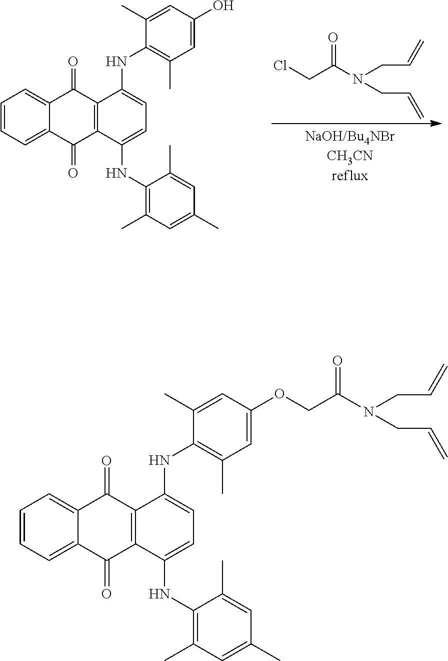 [SMILES: Cc1cc(C)c(Nc2ccc(Nc3c(C)cc(O)cc3C)c3c2C(=O)c2ccccc2C3=O)c(C)c1 ; C=CCN(CC=C)C(=O)CCl ; C=CCN(CC=C)C(=O)COc1cc(C)c(Nc2ccc(Nc3c(C)cc(C)cc3C)c3c2C(=O)c2ccccc2C3=O)c(C)c1]

1-((4-Hydroxy-2,6-dimethylphenyl)amino)-4-(mesitylamino)-anthraquinone (800 mg, 1.679 mmol), N,N-diallyl-2-chloroacetamide (437 mg, 2.517 mmol), sodium hydroxide (134 mg, 3.358 mmol) and tetrabutylammonium bromide (54 mg, 0.168 mmol) were mixed in acetonitrile (20 mL). This suspension was heated up to reflux, and reflux maintained for 16 h before the mixture was cooled to room temperature. The solvent was removed by rotary evaporation, and the solid was separated by column chromatography (silica; CH₂Cl₂/EtOAc 50:1). The product was obtained as a blue powder (784 mg, 76%) after rotary evaporation and drying under dynamic vacuum. ¹H NMR (400 MHz, CDCl₃) δ 11.70 (s, 1H), 11.63 (s, 1H), 8.35 (m, 2H), 7.68 (m, 2H), 6.86 (s, 2H), 6.51 (s, 2H), 6.48 (s, 2H), 5.71 (m, 2H), 5.12 (m, 2H), 4.61 (s, 2H), 3.92 (2d, 4H), 2.23 (s, 3H), 2.08 (br s, 12H). ESI-MS (m/z, MH⁺) 614.30 (calculated); 614.31 (found).

d. Preparation of a Color Resist and a Color Film Comprising an Anthraquinone Dye

1.15 g of alkaline soluble acrylic resin solution (MIPHOTO RPR4022, supplied from Miwan Commercial Co., Ltd., 40 wt % of solid content in methyl 3-methoxypropionate) was mixed with 1.73 g of PGMEA (60 wt %). 0.189 g of Dye 1 was mixed in the alkaline soluble resin/PGMEA solution and stirred for 2 hours at room temperature using a shaker. The solution was filtered through a 0.45 μm PTFE filter to remove large particles. Then the filtered solution was spin coated onto a clean glass substrate with 400 rpm spin speed for 18 seconds. The obtained film was first dried at 90° C. under air atmosphere for 30 minutes, and then hard baked at 230° C. under air atmosphere for 1 hour. The CIE values (xyY values and lab values) and the transmittance were measured before and after the hard bake.

Film thickness and chromaticity coordinates of the obtained film were measured as disclosed below. Film thickness of the film was about 1 micron. Chromaticity coordinates measured by UltraScan Pro (Hunterlab) colorimeter were, x=0.16, y=0.20 and Y=22.

<Performance Evaluation>

(1) Thermal Stability of Dye (Mass Loss Measured by TGA):

The thermal stability of dye itself was determined by the mass loss of dye measured by TGA under air atmosphere at 230° C. for 1 hour. This evaluation reflects chemical stability of the dye itself.

(2) Film Thickness:

Film thickness is measured by scanning the difference in height across the boundary of film and glass substrate with atomic force microscope.

(3) Chromaticity Coordinates:

The chromaticity coordinate of film on a glass sheet is directly recorded with UltraScan Pro (Hunterlab) colorimeter. The light source is D65/10.

(4) Thermal Stability of Films (Chromaticity):

The wet film after spin coating is dried in oven at 90° C. for 30 minutes and then soft baked at 150° C. for 15 minutes. The chromaticity coordinates (L, a, b) are recorded with UltraScan Pro (Hunterlab) colorimeter. D65/10 light source is used and results are based on CIE Lab coordinates. After that the film is hard baked at target temperature (230° C.) for 1 hour and the new chromaticity coordinates (L′, a′, b′) are recorded with the method above. The thermal stability of a film is indicated by the difference of chromaticity coordinate before and after hard baking represented by the following formula;

ΔE=\sqrt{(L−L′)²+(a−a′)²+(b−b′)²}

### Comparative Examples 1 to 3

Same procedure was conducted excepting for the dyes disclosed below were used instead of Dye 1.

### Dye Used in Comparative Example 1

### 1,4-bis((isopropylamino)anthraquinone (Solvent Blue 36)

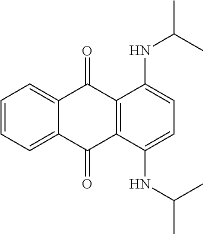 [SMILES: CC(C)Nc1ccc(NC(C)C)c2c1C(=O)c1ccccc1C2=O]

### Dye Used in Comparative Example 2

### 1,4-bis(mesitylamino)anthraquinone (Solvent Blue 104)

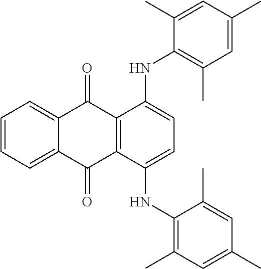 [SMILES: Cc1cc(C)c(Nc2ccc(Nc3c(C)cc(C)cc3C)c3c2C(=O)c2ccccc2C3=O)c(C)c1]

### Dye Used in Comparative Example 3

### (1-((4-hydroxy-2,6-dimethylphenyl)amino)-4-(mesitylamino)-anthraquinone

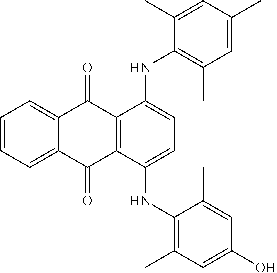 [SMILES: Cc1cc(C)c(Nc2ccc(Nc3c(C)cc(O)cc3C)c3c2C(=O)c2ccccc2C3=O)c(C)c1]

TABLE 1

| | | Solubility in | ΔEab after baking |
|---|---|---|---|
| | | PGMEA | at 230° C. |
| | Dyes | (wt %) | for 1 h |
| Inventive | Dye 1 | 6.2 | 2.1 |
| Example 1 | | | |
| Comparative | Solvent Blue 36 | 1.9 | 33 (color almost |
| Example 1 | | | disappeared) |
| Comparative | Solvent Blue 104 | 0.6 | 7.9 |
| Example 2 | | | |
| Comparative | (1-((4-hydroxy-2,6- | 3.0 | 6.8 |
| Example 3 | dimethylphenyl)amino)- | | |
| | 4-(mesitylamino)- | | |
| | anthraquinone_{—} | | |

Referring to Table 1, it can be found that Example 1 show significant improvement in both thermal stability and solubility in PEGMEA compare with the Comparative Examples.

1. A compound represented by the following formula (1): 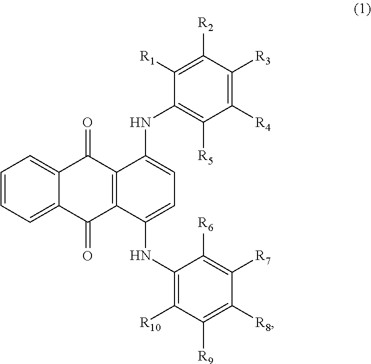
wherein R₁ to R₁₀ are selected from the group consisting of alkyl group having 1 to 20 carbon atoms, halogen atom, hydroxyl group, hydrogen atom, cyano group, sulfonyl group, sulfo group, aryl group, nitro group, alkoxyl group having 1 to 20 carbon atoms and -A-(N,N-diallylamide), wherein A is a linking group of hydrocarbon having 1 to 20 carbon atoms which can contain at least one heteroatom selected from oxygen atom and nitrogen atom, and at least one of R₁ to R₁₀ is -A-(N,N-diallylamide).

2. The compound of claim 1, wherein R₁ to R₁₀ are selected from the group consisting of alkyl group having 1 to 8 carbon atoms, hydrogen atom and -A-(N,N-diallylamide).

3. The compound of claim 1, wherein A is selected from the structure represented by the following formulas (2)-(8):

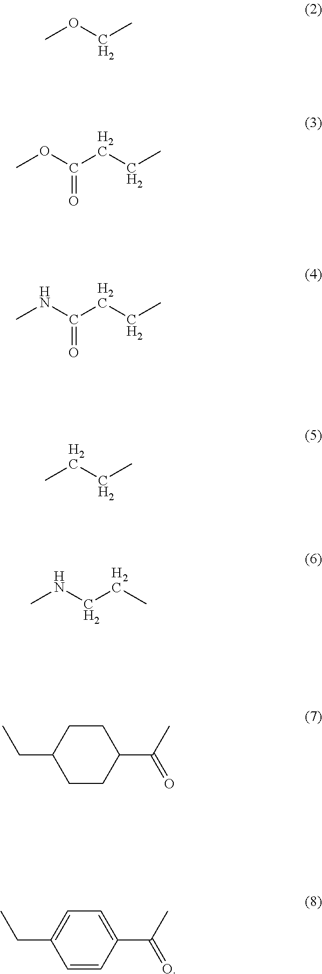

4. The compound of claim 3, wherein A is represented by the formula (2).

5. A composition comprising a compound represented by the following formula (1): 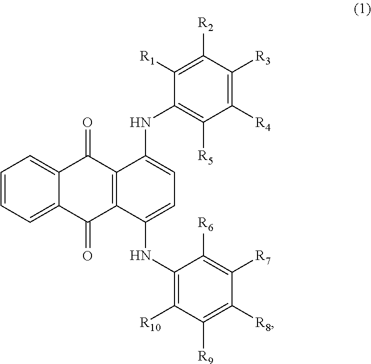
wherein R₁ to R₁₀ are selected from the group consisting of alkyl group having 1 to 20 carbon atoms, halogen atom, hydroxyl group, hydrogen atom, cyano group, sulfonyl group, sulfo group, aryl group, nitro group, alkoxyl group having 1 to 20 carbon atoms and -A-(N,N-diallylamide), wherein A is a linking group of hydrocarbon having 1 to 20 carbon atoms which can contain at least one heteroatom selected from oxygen atom and nitrogen atom, and at least one of R₁ to R₁₀ is -A-(N,N-diallylamide),
and a resin.

6. The composition of claim 5 further comprising a radiation-sensitive compound.

7. An article having a polymer layer formed from the composition of claim 5.

8. The article of claim 7, wherein the polymer layer is a negative-type layer.

9. A color filter formed from the composition of claim 5.

10. A composition comprising a reaction product of a resin with a compound represented by the following formula (1): 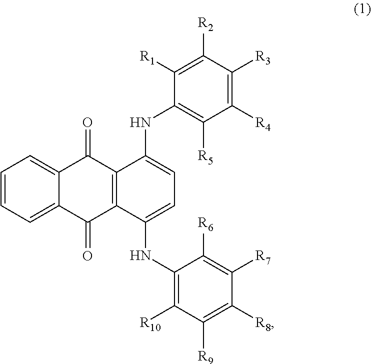
wherein R₁ to R₁₀ are selected from the group consisting of alkyl group having 1 to 20 carbon atoms, halogen atom, hydroxyl group, hydrogen atom, cyano group, sulfonyl group, sulfo group, aryl group, nitro group, alkoxyl group having 1 to 20 carbon atoms and -A-(N,N-diallylamide), wherein A is a linking group of hydrocarbon having 1 to 20 carbon atoms which can contain at least one heteroatom selected from oxygen atom and nitrogen atom, and at least one of R₁ to R₁₀ is -A-(N,N-diallylamide).

11. The composition of claim 10 further comprising a radiation-sensitive compound.

12. An article having a polymer layer formed from the composition of claim 10.

13. The article of claim 12, wherein the polymer layer is a negative-type layer.

14. A color filter formed from the composition of claim 10.
